(19) United States
(12) Patent Application Publication
(10) Pub. No.: US 2025/0207854 A1
(43) Pub. Date: Jun. 26, 2025

(54) TUNNEL-TYPE MICROWAVE VACUUM ULTRA-LOW TEMPERATURE DRYING EQUIPMENT AND MATERIAL DRYING PROCESS

(71) Applicant: Youshengda Microwave Technology (Shanghai) Co., Ltd, Shanghai (CN)

(72) Inventors: Linwen XU, Shanghai (CN); Zeguo SONG, Shanghai (CN); Yanfeng WANG, Shanghai (CN); Yanzhong WU, Shanghai (CN); Huijian HU, Shanghai (CN); Xian LI, Shanghai (CN); Huan YANG, Shanghai (CN)

(21) Appl. No.: 18/959,883

(22) Filed: Nov. 26, 2024

(30) Foreign Application Priority Data
Dec. 25, 2023 (CN) 2023118020899

(51) Int. Cl. F26B 5/04; F26B 25/00

(52) U.S. Cl. CPC F26B 5/048; F26B 25/001; F26B 25/008

(57) ABSTRACT

The present invention discloses a tunnel-type microwave vacuum ultra-low temperature drying equipment and a material drying process for drying a material. The tunnel-type microwave vacuum ultra-low temperature drying equipment comprises: a host device, comprising a chamber and a plurality of microwave generators, wherein the plurality of microwave generators are respectively provided on an outer wall surface of the chamber and sequentially arranged at least along a lengthwise direction of the chamber; a vacuum unit, having a vacuum port connected to the chamber through a pipeline; a chiller unit, having a cooling water pipe connected to the microwave generator, wherein the chiller unit is used to cool the microwave generator. This disclosure enables rapid low-temperature evaporation of water-containing materials in a vacuum environment to achieve drying with high efficiency. In addition, it can also prevent damage to materials caused by excessive temperatures.

### CROSS-REFERENCE TO RELATED APPLICATIONS

The present application claims priority to Chinese Patent Application No. 2023118020899 filed Dec. 25, 2023, the entire contents of which is incorporated by reference herein in its entirety.

### TECHNICAL FIELD

The present disclosure relates to the field of microwave drying, specifically to a tunnel-type microwave vacuum ultra-low temperature drying equipment and a material drying process.

### BACKGROUND

Drying equipment is a large category of mechanical equipment, where traditional drying equipment mainly uses heat sources such as steam, hot water, thermal oil, hot air, electric heat, and infrared. These heat sources are suitable for drying most moist materials. However, some categories of moist materials are not easily dried by traditional drying equipment, accompanied by long drying time, high energy consumption, and even destruction of the physical state of the materials, which has become a bottleneck for some industries.

Microwave, as a drying heat source, differs significantly from the aforementioned heat sources. It does not require a heat transfer medium and directly acts on moist materials, with high thermal efficiency and strong penetrability. Utilizing this characteristic of microwave has led to the development of a type of drying equipment that is used in various industries, primarily in chemical, food, pharmaceutical, paper products, and packaging industries.

Current microwave drying equipment is mostly in an atmospheric-pressure rectangular tunnel structure, or in a single-layer or multi-layer belt-type structure, or is a small vacuum equipment. The application is limited for microwave drying equipment with these structures. Atmospheric-pressure equipment is not suitable for drying flammable, explosive, and heat-sensitive materials, affecting product quality. Small vacuum equipment is not suitable for mass production, restricting its promotion.

### SUMMARY OF THE INVENTION

The technical problem to be solved by the present disclosure is to provide a tunnel-type microwave vacuum ultra-low temperature drying equipment and a material drying process in order to overcome the defects in the prior art.

The present disclosure solves the above technical problem through the following technical solutions:

A tunnel-type microwave vacuum ultra-low temperature drying equipment for drying a material, comprising: a host device, comprising a chamber and a plurality of microwave generators, wherein the chamber has a cylindrical structure with an internal cross-sectional shape of a regular polygon; the plurality of microwave generators are respectively provided on an outer wall surface of the chamber and sequentially arranged at least along a lengthwise direction of the chamber; a vacuum unit, having a vacuum port connected to the chamber through a pipeline; a chiller unit, having a cooling water pipe connected to the microwave generator; the chiller unit is used to cool the microwave generator and a microwave power supply.

The tunnel-type microwave vacuum ultra-low temperature drying equipment utilizes the characteristics of microwave heating that can cause the oscillation of polar molecules, supplemented by the vacuum unit to evacuate the chamber, enabling rapid ultra-low temperature evaporation of water-containing materials in a vacuum environment to achieve drying with high efficiency. In addition, it can also prevent damage to materials caused by excessive temperatures.

The use of a closed regular polygonal structure on the inner wall of the chamber allows it to withstand high vacuum pressure, facilitates microwave refraction, and ensures better microwave action on the material, achieving low-temperature evaporation of moisture and material drying. Additionally, by providing the chiller unit to cool the microwave generator and other devices, it ensures that the microwave generator and other devices operate at a reasonable temperature, thus further improving durability.

Preferably, the chamber comprises a plurality of sections of cylinders and a flange, and the sections of cylinders are connected to each other by the flange; and/or, the chamber has an internal cross-sectional shape of a regular 24-sided polygon; and/or, the chamber is made of mirror-finished stainless steel; and/or, an electric heating pipe is provided at a bottom of the chamber.

By providing flanges to connect the sections of cylinders, such a structural arrangement can strengthen the overall structure of the chamber and ensure the consistency of the overall dimensional parameters.

Preferably, the microwave generators are located on both left and right sides of the chamber, and are provided on the chamber in a position corresponding to a shaped edge of the internal cross-sectional shape of the chamber;

Such a layout is conducive to a wider range of wavelengths, a deeper depth of radiation, and more uniform material drying.

Preferably, the microwave generator comprises a power supply, a waveguide, a mounting flange, and a magnetron; the waveguide is mounted on an outer wall of the chamber by means of the mounting flange through distribution; the waveguide is mounted in conjunction with the magnetron; power is supplied to the magnetron by means of the power supply; the magnetron is controlled to activate and emit microwaves into a cavity of the waveguide, and the microwaves are reflected into the chamber by a cavity wall of the waveguide;

Preferably, quartz glass is provided at a joint of the chamber and the microwave generator.

Preferably, the waveguide is one of a hard waveguide, a soft waveguide, a rectangular waveguide, and an elliptical waveguide.

Preferably, the chamber is provided with a cylindrical vacuum pipe; the vacuum port of the vacuum unit is connected to the cylindrical vacuum pipe through a pipeline; the chamber is provided with a vacuum relief valve; the vacuum relief valve, the cylindrical vacuum pipe, and the microwave generator are staggeredly arranged on a surface of the chamber;

Preferably, the vacuum unit includes one of the following three pumps: (1) a combination of an oil-free screw vacuum pump and a Roots vacuum pump; (2) a water ring vacuum pump; and (3) an oil pump.

Preferably, the tunnel-type microwave vacuum ultra-low temperature drying equipment further comprises an ultra-low temperature water-trapping system; the ultra-low temperature water-trapping system comprises a refrigeration unit, a heat exchanger, an evaporator, and a condenser; the vacuum port of the vacuum unit is connected to the chamber through the condenser and the evaporator of the ultra-low temperature water-trapping system.

By providing the ultra-low temperature water-trapping system to condense the water vapor extracted from the chamber into water for centralized treatment, it avoids excessive humidity in the vacuum pump and ensures that the performance of the vacuum pump is not disturbed.

Preferably, there are two ultra-low temperature water-trapping systems; the vacuum port is connected to the chamber through the condenser of one of the ultra-low temperature water-trapping systems by way of pipeline switching.

Preferably, a cooling water pipe is fixedly mounted at an external interface of the chiller unit; an interface end of the cooling water pipe is fixedly mounted and sealingly connected to a cooling interface end of the power supply and magnetron of the microwave generator;

Preferably, the tunnel-type microwave vacuum ultra-low temperature drying equipment further comprises a cooling tower, which is connected to the chiller unit and is used to provide refrigeration capacity to the chiller unit.

Preferably, the host device further comprises a sealing door and a sealing door moving mechanism; the sealing door is provided at an end of the chamber; the sealing door moving mechanism is connected to the sealing door and is used to drive the sealing door to switch between being closed and open relative to the end of the chamber; when the sealing door is switched to being closed relative to the end of the chamber, the sealing door is sealingly connected to the end of the chamber; when the sealing door is switched to being open relative to the end of the chamber, the end of the chamber opens outward.

Preferably, the tunnel-type microwave vacuum ultra-low temperature drying equipment further comprises a feeding conveyor and a discharging conveyor; the feeding conveyor is correspondingly provided at a feeding end of the chamber, and the discharging conveyor is correspondingly provided at the feeding end of the chamber; the host device further comprises an in-tunnel conveyor provided within the chamber, with both ends of the in-tunnel conveyor extending to the feeding conveyor and the discharging conveyor respectively.

Preferably, the host device further comprises a pressing mechanism, which is provided within the chamber and located above the in-tunnel conveyor; the pressing mechanism is used to secure the material on the in-tunnel conveyor.

Preferably, the tunnel-type microwave vacuum ultra-low temperature drying equipment further comprises an auxiliary device; the vacuum unit and the chiller unit are both provided in the auxiliary device; the auxiliary device is provided separately from the host device; the vacuum unit in the auxiliary device is connected to the chamber in the host device through a vacuum pipe; the chiller unit in the auxiliary device is connected to the microwave generator in the host device through a cooling water pipe.

Preferably, the tunnel-type microwave vacuum ultra-low temperature drying equipment further comprises an electrical control module provided near the host device.

A material drying process that uses the tunnel-type microwave vacuum ultra-low temperature drying equipment as described above for drying a material, specifically comprising the following steps:

The material is fed into the chamber of the host device through the feeding conveyor.

The sealing doors at both ends of the chamber of the host device are closed respectively.

The vacuum unit evacuates the interior of the chamber through a vacuum pipeline.

The microwave generator is activated after achieving a desired vacuum inside the chamber and releases microwave energy to the material, which absorbs microwave and evaporates moisture from the inside out.

After completing the material drying, turning off the microwave generator and activating a cooling system, and controlling the vacuum unit for a full-load vacuum extraction of the chamber to reduce ambient temperature and material temperature in the chamber.

After completing the operation of the cooling system, the vacuum relief valve is opened to evacuate the vacuum in the chamber until the vacuum reaches a vacuum value that allows the sealing door to be opened.

After completing material processing, the sealing doors at both ends of the chamber are opened, and the processed material is transported out through the discharging conveyor.

The tunnel-type microwave vacuum ultra-low temperature drying equipment utilizes the characteristics of microwave heating that can cause the oscillation of polar molecules, supplemented by vacuum and water cooling functions to achieve drying by rapid low-temperature evaporation of water-containing materials in the chamber in a vacuum environment. It makes up the defects of infrared auxiliary heating, air-cooled drying, spray drying, and other drying methods on the market. Meanwhile, an electrical control system ensures reliable operation of the equipment, making it suitable for drying various types of moist materials, especially special categories of flammable, explosive, and heat-sensitive materials.

Preferably, the step of feeding the material into the chamber of the host device through the feeding conveyor further comprises: after transporting the material into the chamber through the in-tunnel conveyor, controlling a pressing cylinder of the pressing mechanism to push a pressing plate onto the material, so as to secure the material and prevent the material from scattering.

Preferably, the step of activating the microwave generator after achieving a desired vacuum inside the chamber and releasing microwave energy to the material, which absorbs the microwave and evaporates moisture from the inside out further comprises at least one of the following three steps: (1) using the vacuum unit to rapidly extract the moisture evaporated inside the chamber to ensure that the chamber is in a high vacuum state, allowing water to have a low boiling point; (2) using the ultra-low temperature water-trapping system to cool the moisture extracted by the vacuum unit, allowing gaseous water to convert into liquid water and be further concentrated; (3) using the chiller unit for water cooling of the magnetron and power supply to maintain normal operation of the microwave generator.

The positive and progressive effects of the present disclosure are as follows.

(I) The tunnel-type microwave vacuum ultra-low temperature drying equipment utilizes the characteristics of microwave heating that can cause the oscillation of polar molecules, supplemented by the vacuum unit to evacuate the chamber, enabling rapid low-temperature evaporation of water-containing materials in a vacuum environment to achieve drying with high efficiency. In addition, it can also prevent damage to materials caused by excessive temperatures.

(II) The use of a closed regular polygonal structure on the inner wall of the chamber allows the tunnel-type microwave vacuum ultra-low temperature drying equipment to withstand high vacuum pressure, facilitates microwave refraction, and ensures better microwave action on the material, achieving low-temperature evaporation of moisture and material drying.

(III) By providing the chiller unit to cool the microwave generator and other devices, the tunnel-type microwave vacuum ultra-low temperature drying equipment ensures that the microwave generator and other devices operate at a reasonable temperature, thus further improving durability.

(IV) By providing the ultra-low temperature water-trapping system to condense the water vapor extracted from the chamber into water for centralized treatment, it avoids excessive humidity in the vacuum pump and ensures that the performance of the vacuum pump is not disturbed.

### BRIEF DESCRIPTION OF THE DRAWINGS

FIG. 1 shows a schematic diagram of the structure of the tunnel-type microwave vacuum ultra-low temperature drying equipment according to an example of the present disclosure.

FIG. 2 shows a schematic diagram of the structure of the host device according to an example of the present disclosure.

FIG. 3 shows a schematic diagram of the structure of the host device according to an example of the present disclosure, in which the chamber and the sealing door are hidden.

FIG. 4 shows a schematic diagram of the structure of the chamber according to an example of the present disclosure.

FIG. 5 shows a schematic diagram of the local structure of the chamber according to an example of the present disclosure.

FIG. 6 shows a front view of the local structure of the chamber according to an example of the present disclosure.

FIG. 7 shows a schematic diagram of the structure of the microwave generator according to an example of the present disclosure.

FIG. 8 shows a schematic diagram of the structure of the sealing door moving mechanism according to an example of the present disclosure.

FIG. 9 shows a schematic diagram of the connection relationship of the tunnel-type microwave vacuum ultra-low temperature drying equipment according to an example of the present disclosure.

FIG. 10 shows a schematic diagram of the structure of the auxiliary device according to an example of the present disclosure.

FIG. 11 shows a schematic diagram of the structure of the vacuum unit and the ultra-low temperature water-trapping system according to an example of the present disclosure.

FIG. 12 shows a schematic diagram of the local structure of the tunnel-type microwave vacuum ultra-low temperature drying equipment according to an example of the present disclosure.

FIG. 13 shows a flow chart of the material drying process of the tunnel-type microwave vacuum ultra-low temperature drying equipment according to an example of the present disclosure.

The reference numerals are as follows:
host device 1
chamber 101
frame 102
sealing door 103
microwave generator 104, power supply 1045, waveguide 1042, mounting flange 1041, magnetron 1043, water injection port 1044
power supply cooling water pipe 107
vacuum relief valve 108
pressing mechanism 109, pressing cylinder 1091, pressing plate 1092
in-tunnel conveyor 111
vacuum pipe 112
feeding conveyor 2
discharging conveyor 3
vacuum unit 4
chiller unit 5
cooling tank 6
cooling tower 7
vacuum pipeline 8
cooling water pipe 9
ultra-low temperature water-trapping system 10
evaporator 1001, condenser 1002, refrigeration unit 1003
auxiliary device 11
sealing door moving mechanism 12, drive motor 129, positioning guide shaft 125, transmission shaft 128, chain 123, safety lock 126, cylinder 124, safety lock hole column 122, power sprocket 121
water collection system 14

### DETAILED DESCRIPTION OF THE PREFERRED EMBODIMENT

The present disclosure is further described below by means of examples, but the present disclosure is not thereby limited to the scope of the described examples.

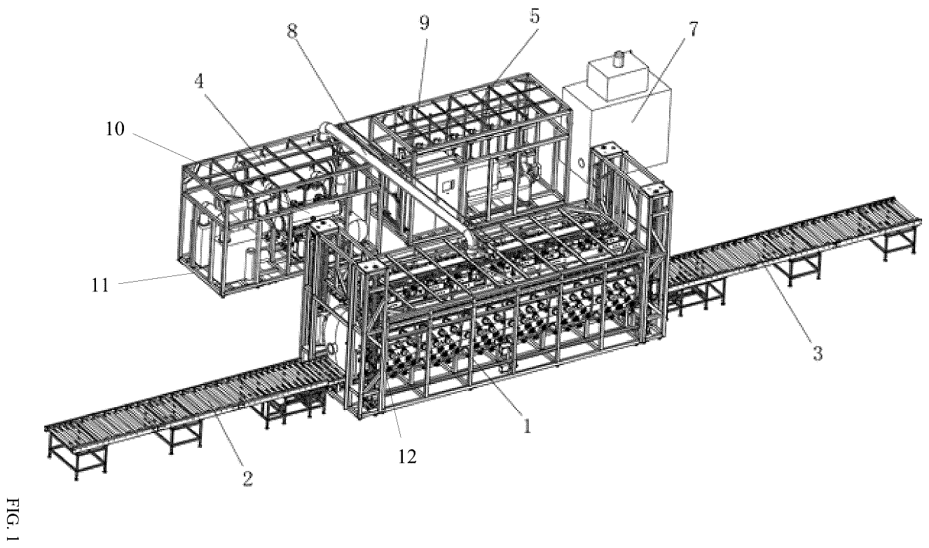

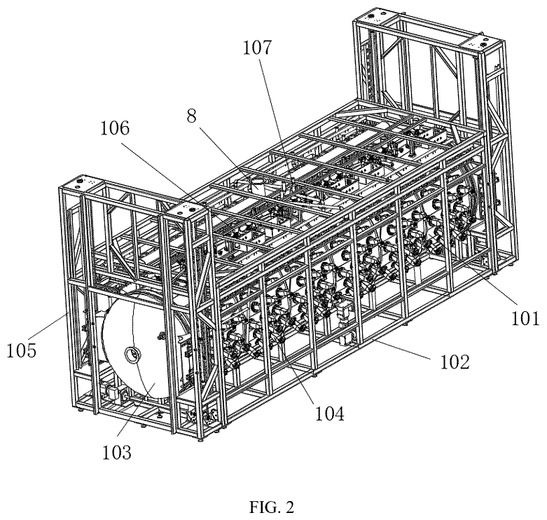

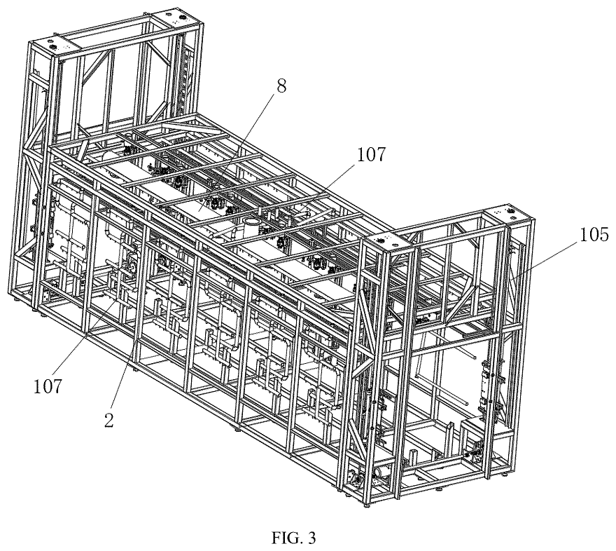

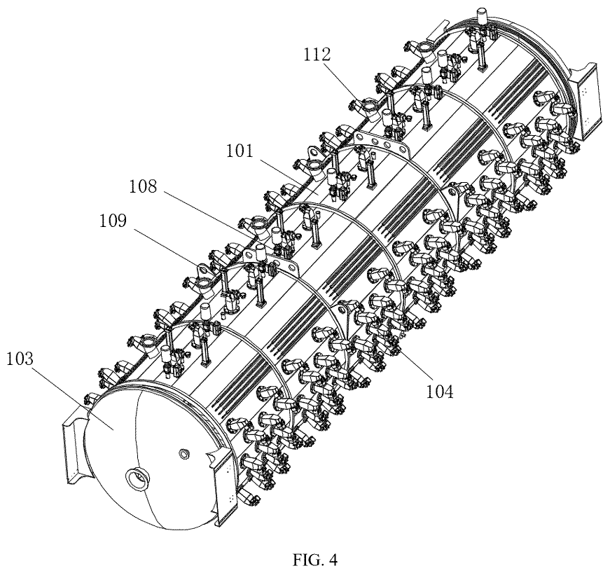

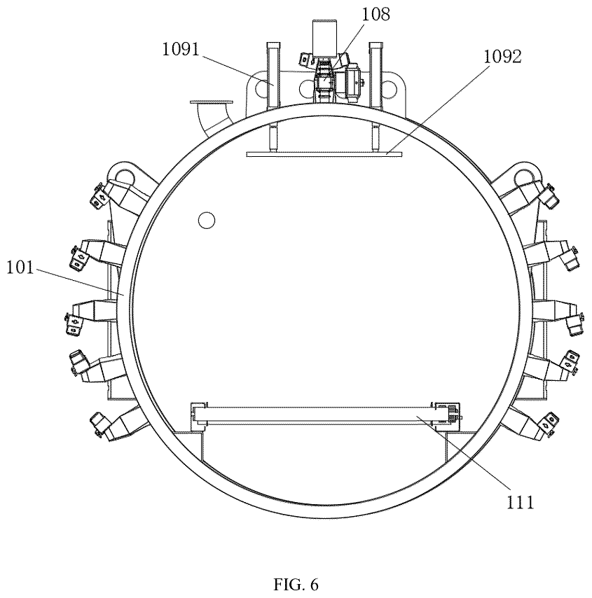

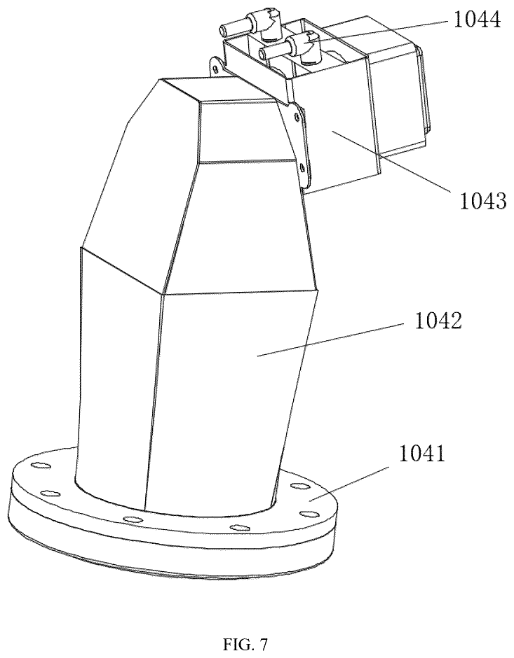

As shown in FIGS. 1 to 8, the present disclosure provides a technical solution: a tunnel-type microwave vacuum ultra-low temperature drying equipment, comprising a host device 1. The host device 1 further comprises a chamber 101, a frame 102, and a sealing door 103. The chamber 101 is provided on the frame 102, specifically in the form of a cylindrical structure. The chamber 101 is arranged horizontally, whose interior is used to accommodate materials for low-temperature drying. The sealing door 103 is used to seal the opening of the chamber 101 and can be switched between open and closed states relative to the opening of the chamber 101, so as to enable the materials to enter the chamber 101 by opening the sealing door 103 and to form a closed environment inside the chamber 101 by closing the sealing door 103.

In order to heat the materials in the chamber 101 to speed up the drying, a plurality of microwave generators 104 are arranged outside the chamber 101 in accordance with specific rules. The microwave generator 104 specifically comprises a power supply 1045, a waveguide 1042, a mounting flange 1041, and a magnetron 1043, wherein the waveguide 1042 is mounted on an outer wall of the chamber 101 by means of the mounting flange 1041; the waveguide 1042 is mounted in conjunction with the magnetron 1043; power is supplied to the magnetron 1043 by means of the power supply 1045; the magnetron 1043 is controlled to activate and emit microwaves into a cavity of the waveguide 1042; the microwaves are then reflected into the chamber 101 by a cavity wall of the waveguide 1042 and act on the materials in the chamber 101 for microwave drying treatment; a water injection port 1044 is provided on the outside of the magnetron 1043 for injecting cooling water and cooling the waveguide 1042 and the magnetron 1043, so as to ensure the continuous normal operation of the microwave generator. In addition, a light-transmitting barrier structure, specifically quartz glass, is provided at a joint of the cavity of the waveguide 1042 and the outer wall of the chamber 101. Providing the quartz glass to block the waveguide 1042 and the chamber 101 can firstly increase the energy concentration of the microwaves into the chamber 101, which is conducive to the concentration and diffusion of the microwaves, and it can also effectively prevent the waveguide 1042 from being contaminated, thus ensuring the degree of cleanliness within the magnetron 1043.

There are many types of waveguides 1042 that can be used in this example. The waveguide 1042 may be one of a hard waveguide, a soft waveguide, a rectangular waveguide, and an elliptical waveguide. Each type of waveguide has a different national implementation standard and a fairly wide range of applications. In the field of industrial applications, the unique functions and characteristics of the waveguide can be exerted based on the structural characteristics of the waveguide and according to the effect of the waveguide.

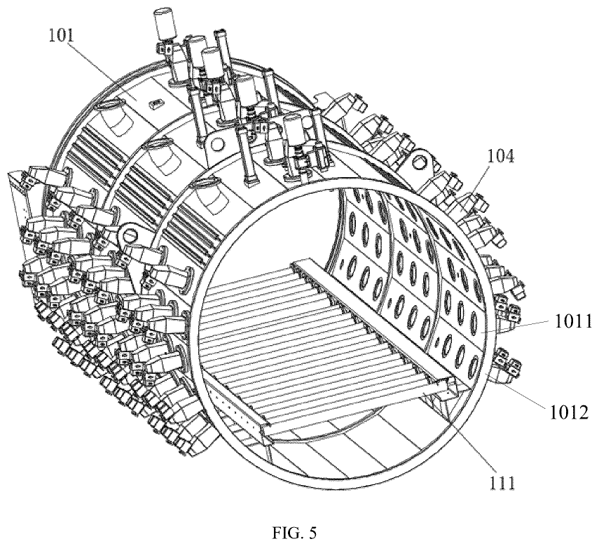

As shown in FIG. 5, an inner surface of the chamber 101 is formed by bending a stainless steel mirror panel 1011 into a regular polygon, and the stainless steel mirror panel 1011 is arranged with the mirror facing inward, which is conducive to microwave refraction. Due to the difficulty in processing and manufacturing long annular regular polygonal stainless steel mirror panels 1011, the stainless steel mirror panel 1011 of the entire chamber 101 is divided longitudinally into a plurality of sections of cylinders, which are respectively formed by bending the stainless steel mirror panel 1011. A flange 1012 is welded between the plurality of sections of cylinders, allowing the sections of cylinders to be assembled together with the flange 1012 to form a sealed tunnel cavity. Furthermore, providing the flange 1012 can strengthen the overall structure of the chamber 101 and ensure the consistency of the overall dimensional parameters. Specifically, the chamber 101 is fixedly mounted within the frame 102; a sealing door frame 105 is provided at both ends of the frame 102; the sealing door 103 is provided at both ends of the host device 1, specifically at the front and rear ends of the chamber 101; the host device 1 implements a material drying process through the closing and opening of the sealing door 103, which is specifically mounted within the sealing door frame 105.

By bending the stainless steel mirror panel 1011 into a regular polygon to form the chamber 101, the specific angle of the panel is set based on the angle of the microwave radiation. Such an angle setting on the polygonal panel facilitates further refraction of microwaves so as to better act on the materials, thereby accelerating the drying process. Specifically, in this example, the stainless steel mirror panel 1011 forming the chamber 101 is in the shape of a regular 24-sided polygon, and each microwave generator 104 is provided corresponding to the shaped edge of the 24-sided polygon. It is certain that in other examples, the use of regular polygons with different numbers of sides can also achieve improved microwave refraction. Additionally, the use of any number of shaped edges to form a chamber equivalent to a circle can also achieve microwave refraction.

In order to further heat the materials in the chamber 101 to speed up the drying, a cylindrical vacuum pipe 112 is provided above the side of the chamber 101. The cylindrical vacuum pipe 112 is sealingly connected to the interior of the chamber 101 for vacuum extraction to create a vacuum inside the chamber 101. Meanwhile, a vacuum relief valve 108 is mounted directly above the chamber 101 for releasing the vacuum inside the chamber 101.

By providing the cylindrical vacuum pipe 112 to construct a high vacuum environment inside the chamber 101, utilizing the characteristics of the reduced boiling point of water under vacuum, supplemented by the penetrability and thermal effect of microwaves generated by the microwave generator 104, low-temperature drying of materials in a vacuum environment is achieved. Specifically, inside the chamber 101 having a tunnel structure that is closed, polygonal, and can withstand vacuum pressure, using microwaves generated by the microwave generator 104 as a heat source, heating moist materials under the vacuum environment constructed by the cylindrical vacuum pipe 112 can achieve low-temperature evaporation of moisture in the materials to meet the demand for material drying.

In order to improve the drying effect and uniformity of the microwave generator 104 on the materials, a plurality of microwave generators 104 are uniformly arranged on both left and right sides of the chamber 101, which are staggeredly arranged in a row on the side walls of the chamber 101 to achieve uniform irradiation on the materials. Meanwhile, the microwave generators 104 are arranged on both left and right sides of the chamber 101, while the cylindrical vacuum pipe 112 is arranged above the side of the chamber 101, and the vacuum relief valve 108 is arranged directly above the chamber 101, so that the components do not interfere with each other, which is conducive to providing sufficient operating space for the wiring connection and piping connection of the components.

Specifically, the tunnel-type microwave vacuum ultra-low temperature drying equipment in this example is also provided with a vacuum unit 4 for generating a vacuum, and the external end of the vacuum unit 4 is fixedly mounted with a vacuum pipeline 8. An interface end of the vacuum pipeline 8 is fixedly mounted and sealingly connected to an interface end of the cylindrical vacuum pipe 112, allowing the vacuum unit 4 to evacuate the inner cavity of the chamber 101 through the vacuum pipeline 8 and the cylindrical vacuum pipe 112, so as to activate the microwave generator 104 for low-temperature drying of the materials after a certain vacuum is reached.

In this example, in order to further improve the vacuum to reduce the boiling point of water, the vacuum unit 4 uses a combination of various vacuum pumps, and mainly consists of an oil-free screw vacuum pump and a Roots vacuum pump. The purpose is to extract the water vapor evaporated from the chamber 101 of the host device to ensure the vacuum in the chamber, which is conducive to the microwave drying treatment of materials under vacuum and low temperature conditions. It is certain that in other examples, in order to ensure that the vacuum unit 4 can effectively reduce the vacuum of the chamber 101, and thus reduce the boiling point of water to achieve ultra-low temperature drying, the vacuum unit 4 can also use a water ring vacuum pump or an oil pump for vacuum extraction.

It is necessary to specify that for the tunnel-type microwave vacuum ultra-low temperature drying equipment provided herein, the concept of “low temperature” and “ultra-low temperature” refers to allowing the vacuum of the chamber 101 to be in a low state under the continuous operation of the vacuum unit 4 to reduce the boiling point of water, making it easier for water molecules to evaporate, while ensuring the stability of the physical state of the materials. Specifically, as the vacuum increases, the boiling point of water will gradually decrease. When the boiling point of water decreases to below 50° C., drying by the operation of the microwave generator is considered a low-temperature drying state. When the boiling point of water decreases to close to 0°, drying by the operation of the microwave generator is considered an ultra-low temperature drying state.

In this scheme, by providing the vacuum unit 4 to continuously evacuate the chamber 101, the boiling point of water can be kept below 0° C. to achieve ultra-low temperature drying of the materials, and to avoid excessive drying temperature that may affect the physical state of the materials.

In order to ensure the ambient temperature of the chamber 101, a reverse auxiliary heating system is further provided in this scheme. In this example, the reverse auxiliary heating system is specifically an electric heating pipe arranged at a bottom of the chamber 101. By turning on the electric heating pipe for auxiliary heating of the chamber 101, the ambient temperature inside the chamber 101 is kept within a reasonable range by means of electric heating when the temperature of the chamber 101 is low, which also facilitates the evaporation of the water vapor on the inner wall of the chamber 101, allowing the water vapor in the chamber 101 to be further evaporated and withdrawn from the chamber 101 to construct a more favorable drying environment in the chamber 101. Further, an outer peripheral side surface of the chamber 101 is also covered with a thermal insulation material to reduce temperature conduction between the inside and outside of the chamber 101 and to reduce energy consumption.

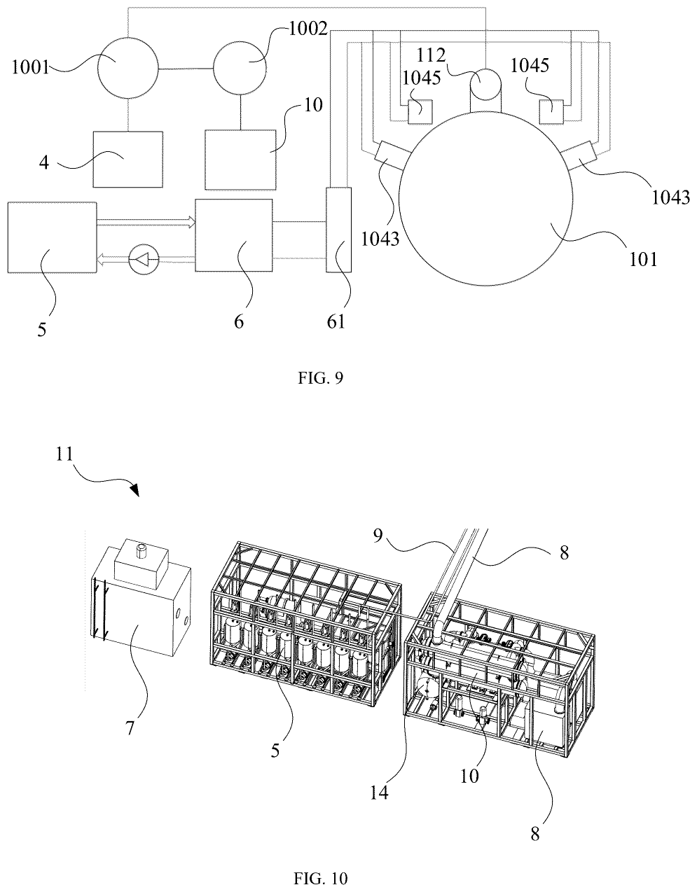

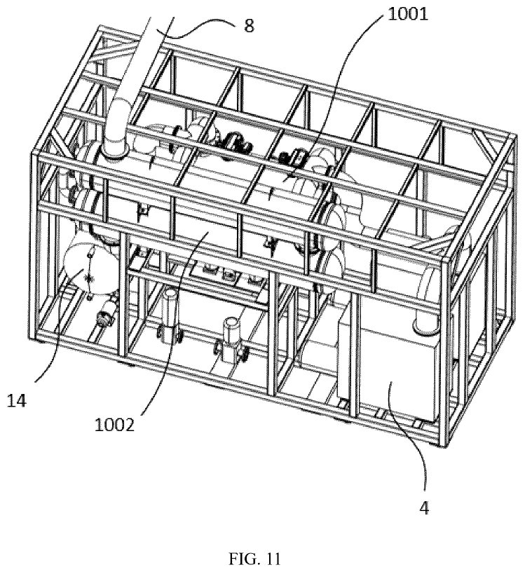

In order to collect the water vapor within the gas extracted from the chamber 101 by the vacuum unit 4, as shown in FIGS. 10 to 12, the vacuum unit 4 provided in this example is further provided with an ultra-low temperature water-trapping system 10 for the purpose of water vapor collection. Specifically, as shown in FIG. 9, the ultra-low temperature water-trapping system 10 includes a refrigeration unit 1003, a heat exchanger, an evaporator 1001, and a condenser 1002. Herein, the refrigeration unit 1003 and the heat exchanger work together for providing refrigeration capacity to the evaporator 1001 and the condenser 1002. By introducing the low-pressure steam extracted from the chamber 101 by the cylindrical vacuum pipe 112 into the evaporator 1001 and the condenser 1002 in sequence, the water vapor in the low-pressure steam is condensed into liquid water for rapid cooling of the condensed water droplets, so as to achieve freezing and trapping of the water vapor in the low-pressure steam, and to effectively avoid the water vapor from further entering into the vacuum pump of the vacuum unit 4 to affect the normal operation of the vacuum pump. Herein, the water droplets collected in the evaporator 1001 and the condenser 1002 can be further collected into a water collection system 14 for subsequent utilization. Specifically, the vacuum unit 4 is connected to the cylindrical vacuum pipe 112 on the chamber 101 through the evaporator. Under the condensation treatment of the ultra-low temperature water-trapping system 10, the extracted water vapor is condensed into water for centralized treatment, which ensures that the performance of the vacuum unit 4 is not disturbed and that the equipment is able to continue drying the materials under the ultra-low temperature state, and avoids the generated water vapor from affecting the vacuum unit 4.

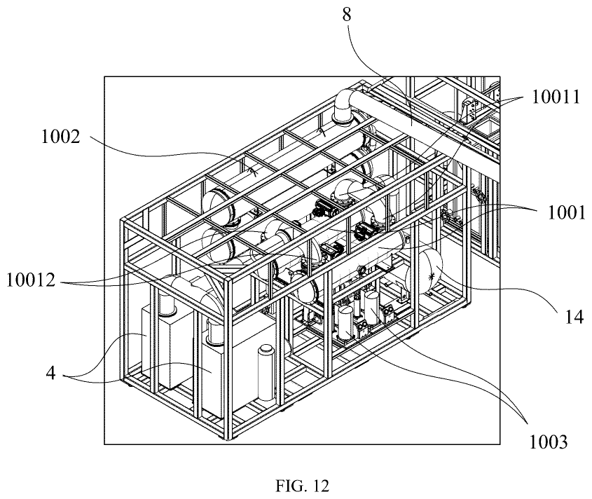

Since the evaporator 1001 carries out the water replenishment at a low operating temperature, the water droplets obtained by condensation from the water vapor may be further frozen into ice. In order to solve the purpose of how to thaw and how to collect the low-temperature water/ice, the ultra-low temperature water-trapping system 10 in this example mainly consists of two refrigeration units 1003, two plate heat exchangers, and two evaporators 1001, as shown in FIG. 12. Herein, the refrigeration unit used consists of a refrigeration compressor, an oil separator, a water separator, a liquid storage pipe, a filter, a regenerator, an expansion valve connecting line, and a mounting base plate bracket, which allows for double-acting operation of the refrigeration unit, with a choice of whether to operate in a refrigeration mode or in a heating mode. By providing two relatively independent ultra-low temperature water-trapping systems 10, in case of ice formation in the cylinder of the evaporator 1001 of one ultra-low temperature water-trapping system 10, the low-temperature steam can be transported to the cylinder of the evaporator 1001 of the other ultra-low temperature water-trapping system 10 for water trapping by way of pipeline switching. Meanwhile, the refrigeration unit of the first ultra-low temperature water-trapping system switches to the heating mode and outputs heat to thaw the ice in the cylinder of the evaporator 1001 into water. Switching between the two ultra-low temperature water-trapping systems in this way can solve the problem of frozen water that is difficult to collect.

Herein, the plate heat exchanger uses the cooling water from an external cooling tower to exchange heat with the refrigerant of the refrigeration unit. The refrigerant passes through an expansion valve to lower the temperature and then enters the evaporator 1001. In this example, as shown in FIG. 12, the evaporators 1001 of the two ultra-low temperature water-trapping systems have a duplex structure, and the specially designed heat exchange fin group in the evaporator 1001 is mounted in the horizontal cylinder. The duplex cylinders of the evaporator 1001 have a total of four inlets and outlets, including two inlets 10011 for connecting to the vacuum pipeline 8, and two outlets 10012 for connecting to the vacuum unit 4. Butterfly valves are provided on the inlet 10011 and the outlet 10012, respectively. Switching of the butterfly valves allows the low-pressure steam extracted from the chamfer 101 to be introduced into the two cylinders of the evaporator 1001, respectively, and to switch between a first cylinder and a second cylinder. The two refrigeration units and the two evaporators 1001 with the duplex cylinders cooperate for simultaneous switching, allowing the refrigeration unit 1003 and the corresponding evaporator 1001 to alternate between the freezing and trapping mode and the heating and defrosting mode, so that the whole is in a continuous working state. Herein, liquid water after heating and defrosting can be collected and automatically discharged through a water collection tank and an automatic drainage device connected to the evaporator 1001.

In addition, the tunnel-type microwave vacuum ultra-low temperature drying equipment further comprises a chiller unit 5 and a cooling tower 7, wherein the chiller, in addition to providing refrigeration capacity for the condensation and trapping of the evaporated low-pressure steam, also provides refrigeration capacity for the cooling of the microwave system to ensure the smooth progress of the process of low-temperature drying of the materials. The cooling tower 7 is used to work with the chiller unit 5. A cooling water pipe 9 is fixedly mounted at an external interface of the chiller unit 5. A power supply cooling water pipe 107 is fixedly mounted at an outer support of the frame 102. The interface end of the cooling water pipe 9 is fixedly mounted and sealingly connected to an interface end of the power supply cooling water pipe 107, and the other interface end of the power supply cooling water pipe 107 is connected to the water injection port 1044 to transport the cooling water to the magnetron 1043 and its power supply. The use of the chiller unit 5 for water cooling of the microwave generator and its power supply 1045 maintains the normal operation of the microwave generator and ensures the service life of the magnetron 1043. Herein, the power supply cooling water pipe 107 is fixed using the outer support structure of the frame 102, so that the structural consistency of the entire host device 1 is high.

Further, the tunnel-type microwave vacuum ultra-low temperature drying equipment further comprises a cooling tank 6. The refrigeration capacity generated by the chiller unit 5 is replaced with low-temperature cold water through water filled with antifreeze in the cooling tank 6, and then transported to the magnetron 1043 and the power supply 1045 through the cooling system 61. The cooling tank 6 is specially designed to ensure the heat exchange with the chiller and to ensure that each heat exchange system using cold water can extract low-temperature cold water. The cooperation of the cooling tank 6 and the cooling tower 7 enables the normal operation of the chiller unit 5 to continuously output refrigeration capacity.

In this example, as shown in FIG. 1, the tunnel-type microwave vacuum ultra-low temperature drying equipment comprises an auxiliary device 11 in addition to the host device 1; the vacuum unit 4 and the chiller unit 5 are both provided inside a device framework of the auxiliary device 11. As can be seen from FIG. 10, the device framework of the auxiliary device 11 is completely independent with respect to the frame 102 of the host device 1, allowing the entire tunnel-type microwave vacuum ultra-low temperature drying equipment to be provided in modules. Specifically, the host device 1 can be provided inside the plant, specifically in an area with high cleanliness, and the auxiliary device 11 can be provided outside the plant to avoid the work of the internally provided vacuum unit 4 and chiller unit 5 from affecting the cleanliness inside the plant, while the space required inside the plant is relatively smaller. Herein, the vacuum unit 4 extends horizontally from the top of the auxiliary device 11 to the top of the chamber 101 within the host device 1 through a pipeline for connecting to the vacuum pipe 112, while the cooling water pipe 9 of the chiller unit 5 also extends horizontally from the top of the auxiliary device 11 to the host device 1 for cooling the components within the host device 1.

The layout scheme of providing host device 1 and auxiliary device 11 respectively can effectively reduce the volume of each component in the tunnel-type microwave vacuum ultra-low temperature drying equipment and meet the needs of plant layout in different plant areas. Further, as shown in FIG. 1, the vacuum unit 4 and the chiller unit 5 in the auxiliary device 11 are also located in two different device frameworks to further achieve a modular layout.

The following is a detailed description of the specific structure setting scheme and control principle of each component in the host device 1.

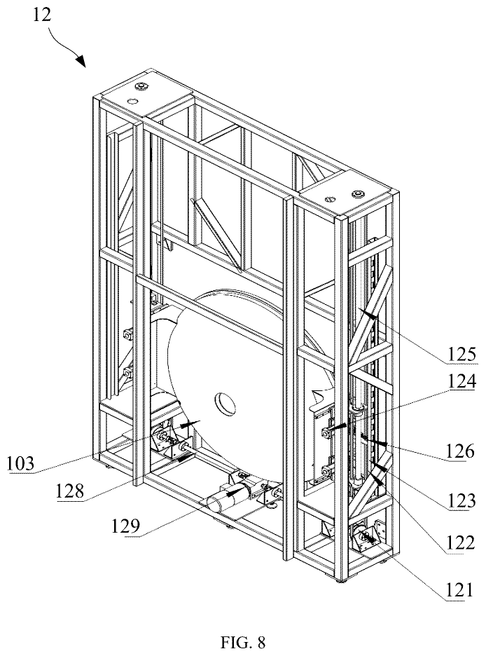

As shown in FIG. 8, the sealing door 103 of this host device may be a lifting sealing door, a translation sealing door, a scissor sealing door, a smooth sealing door, etc., and is specifically a lifting sealing door in this example. The frame 102 is provided with a sealing door moving mechanism 12, which is a component for controlling the upward and downward movement of the sealing door 103 located at the front and rear ends of the chamber 101, and has a power mechanism for opening or closing the sealing door 103. When the sealing door moves down and seals the chamber 101, it allows the drying equipment to perform operations such as vacuuming, drying, and cooling of the materials. The sealing door moving mechanism 12 specifically includes a drive motor 129, a positioning guide shaft 125, a transmission shaft 128, a chain 123, a safety lock 126, a detection switch, a cylinder 124, and other components. The transmission shaft 128 is driven by the drive motor 129 to drive the chain 123 for transmission, so as to drive the sealing door 103 connected to the chain 123 for upward and downward movement. When the sealing door 103 descends to seal the chamber 101, a horizontal thrust is applied to the sealing door 103 by the cylinder to cause the sealing door 103 to be pressed against the chamber 101, ensuring that the degree of sealing meets the requirements.

Herein, the positioning guide shafts 125 are mounted on the left and right sides of the sealing door 103, which serve to fix the moving direction of the sealing door 103 to avoid deviation. The transmission shafts 128 are mounted on both sides of the motor, which serve to connect the transmission between the motor and a power sprocket 121, and to drive the chain 123 through the power sprocket 121 to provide power for the sealing door 103 to move up and down. The safety locks 126 are mounted on both sides of the sealing door 103. The supporting frame plates on both sides are mounted with a safety lock hole column 122. The sealing door mechanism is mounted with a detection switch. When the sealing door moves to a certain position or in an unexpected situation, the safety lock will be triggered, and the cylinder 124 will push the safety lock column to insert into the safety lock hole column 122 for emergency braking, which ensures the safety of the operation of the equipment.

Regarding how materials are transported to the chamber 101 and how dried materials are transported out from the chamber 101, the tunnel-type microwave vacuum ultra-low temperature drying equipment is correspondingly provided with three conveying lines, namely a feeding conveying line, a discharging conveying line, and an in-tunnel conveying line. Herein, the feeding conveying line is a feeding conveyor 2, and the discharging conveying line is a discharging conveyor 3, both of which have substantially the same structure and are respectively provided at the inlet end and the outlet end of the chamber 101, specifically including a conveying line support frame, a roller conveyor, and a transition telescoping jacking transplanting line. The main components of the feeding and discharging conveying lines are made of stainless steel to meet the cleanliness requirements during material transportation. Both the feeding and discharging conveying lines are equipped with transition telescoping, jacking, and transplanting functions. The power used is a cylinder and a motor to realize the telescoping, jacking, and transplanting functions, so as to enable the end of the feeding conveyor 2 and the discharging conveyor 3 close to the chamber 101 to avoid the sealing door 103 and to avoid collision between the two when the sealing door 103 is opened or closed. Specifically, the feeding conveyor 2 and the discharging conveyor 3 are respectively connected to the inlet and outlet of the host device 1. The materials enter the chamber 101 of the host device 1 through the feeding conveyor 2. The processed materials are transported out from the discharging conveyor 3 through the chamber 101.

It is certain that in other examples, the chamber 101 may also be closed at one end and open at the other end, with only one inlet and outlet provided, so that the materials are transported into or out of the chamber 101 through the same inlet and outlet. In this case, the sealing door 103 only needs to be provided at the inlet and outlet to open or close the inlet and outlet. Meanwhile, the feeding and discharging conveying lines are combined into a single conveying line, through which the materials are transported into or out of the chamber 101. In this case, a transplanting mechanism may preferably be provided on the conveying line to further optimize the flow of the materials to be dried and the dried materials on the conveying line.

The in-tunnel conveying line is mounted inside the chamber 101, and is specifically an in-tunnel conveyor 111. Due to the closed environment inside the chamber 101, the driving shaft providing power to the in-tunnel conveyor 111 extends outside the cylinder wall of the chamber 101 through a sealing transmission device for connecting to the motor located on the outside. The in-tunnel conveyor 111 serves to realize the automatic entry and exit of the materials in the chamber. Meanwhile, in order to improve the drying effect, when the microwave generator 104 is turned on to heat and dry the materials, the materials can also be driven by driving the in-tunnel conveyor 111 to move back and forth within the chamber 101 to improve the heating uniformity. The reciprocating movement is usually set at around 200 mm.

In addition, a pressing mechanism 109 is also provided in the chamber 101. The pressing mechanism 109 is mounted on both sides of the top of the chamber 101 and is located directly above the in-tunnel conveyor 111. The pressing mechanism 109 specifically includes a pressing cylinder 1091, which sealingly penetrates the chamber 101 from the outside of the chamber 101 and extends to the interior of the chamber 101. A pressing plate 1092 is fixedly mounted at the end of a telescopic end of the pressing cylinder 1091. When the material is conveyed into the chamber 101 by the in-tunnel conveyor 111, the pressing cylinder 1091 pushes the pressing plate 1092 down to cover the top of the material, so as to secure the material and prevent the material from scattering. If the in-tunnel conveyor needs to move the material back and forth to improve the heating uniformity when the microwave generator 104 is turned on to heat and dry the material, the pressing cylinder 1091 needs to drive the pressing plate 1092 upward so that the material can move back and forth on the in-tunnel conveyor.

In this example, the feeding and discharging conveying lines are also connected to the frame 102. The frame 102 of the host device 1 is a monolithic framework and is used to support and mount all of the systems within the host device 1. The outer surface of the frame 102 is covered with a host outer covering plate (not shown in the drawings), making the overall appearance more aesthetically pleasing. In other examples, the feeding conveying line, the discharging conveying line, and the in-tunnel conveying line can also realize the conveying by using other structures in the prior art other than conveyors, for example by using conveyor belts, conveyor pushers, and other solutions.

In addition, the tunnel-type microwave vacuum ultra-low temperature drying equipment further comprises an electrical control system, and the relevant electrical control module is mainly provided in an electrical cabinet near the host device. The system architecture of the electrical control system is divided into several subsystems, namely material conveying system, door opening and closing system, heating system, vacuum system, freezing and refrigeration system, ultra-low temperature water-trapping system, microwave system, heat dissipation system, drainage system, formula system, detection system, cooling system, alarm system, communication control system, monitoring system, surveillance system, and remote monitoring system.

In terms of equipment operation, the tunnel-type microwave vacuum ultra-low temperature drying equipment is mainly turned on by an on-site operator or a personnel in the main control room of the equipment with one click for the fully automatic operation, or the operation can be selected between manual control and automatic control. When the equipment is turned on, the electrical control system will work according to the set mode of operation, thus enabling unmanned automatic production.

The following is a brief description of the role of each subsystem of the electrical control system.

(1) Material conveying system: After the operation of the electrical control system, whether the material on each conveyor meets the preset value is firstly detected. Specifically, the material parameters, especially those on the feeding conveyor 2, can be detected through a sensor arranged on each conveyor. The sensor that can be used includes an in-place sensor, a temperature sensor, a humidity sensor, etc. Meanwhile, whether there are materials to be dried or materials that have been dried, and whether there is material accumulation at the discharge port of the chamber 101 are detected for the in-tunnel conveyor 111 in the chamber 101. After automatically determining the completion, the system drives the material to be conveyed into the chamber 101 or directly implements the next step.

(2) Door opening and closing system: When the material conveying detector completes the detection to confirm that the materials to be dried have been located in the chamber 101, the electrical control system drives the sealing door moving mechanism 12 to close the sealing door 103, runs the sealing door 103 to be placed into the detector, and sends back the signal that the sealing door 103 has been closed to the electrical control system, thus completing the door closing step. Herein, detecting whether the sealing door 103 is closed can be realized by providing an in-place sensor on the chamber 101 to detect the position of the sealing door 103.

(3) Heating system: The electric heating pipe is turned on for heating based on the temperature of the chamber 101, which is obtained based on the temperature sensor arranged in the chamber 101. Heating is divided into startup heating and heating following the system operation process. After setting the temperature parameters and selecting the heating method, the heating device (electric heating pipe) is activated.

(4) Vacuum system: The vacuum system mainly controls the multiple vacuum units of the vacuum unit 4 to be sequentially turned on to evacuate the chamber 101. Specifically, after the sealing door 103 is closed, the oil-free screw vacuum pump and the Roots vacuum pump are activated in sequence, and the vacuum in the chamber 101 where the materials are located is pumped to −100 Kpa in the shortest possible time.

(5) Freezing and refrigeration system: The freezing and refrigeration system mainly controls the chiller unit 5 to operate synchronously with other components such as the vacuum unit 4. After setting the temperature parameters of the low-temperature cold water, the chiller unit 5 operates in a constant-temperature mode according to the set temperature, so as to meet the refrigeration capacity of the entire equipment and to avoid excessive temperature of each component.

(6) Ultra-low temperature water-trapping system: The ultra-low temperature water-trapping system is also activated following the vacuum system and the freezing and refrigeration system. After the vacuum unit 4 has started operating, the compressor of one of the refrigeration units in the ultra-low temperature water-trapping system is activated and operates at full load or at the set temperature. The compressor of the other refrigeration unit automatically determines whether the heating mode needs to be turned on for defrosting. The two compressors operate alternately on a time basis to achieve the purpose of water trapping and defrosting, removing the low-pressure steam extracted from the chamber 101 by the vacuum unit 4.

(7) Microwave system: When the vacuum inside the chamber 101 reaches the set pressure under the continuous operation of the vacuum unit 4, the power supply 1045 and the magnetron 1043 are controlled to operate. The microwave system automatically controls the output power of the magnetron 1043 according to the formula set value to achieve the required process requirements for effective drying of materials.

(8) Heat dissipation system: the heat dissipation system consists of multiple devices provided throughout the tunnel-type microwave vacuum ultra-low temperature drying equipment, specifically including external circulating water heat dissipation, magnetron cooling water heat dissipation, microwave power supply cooling water heat dissipation, and ultra-low temperature water-trapping system plate heat exchanger heat dissipation, in order for heat dissipation of the various important components in the tunnel-type microwave vacuum ultra-low temperature drying equipment to avoid excessive temperature during the operation of the equipment that affects the stability of the operation of the equipment. Herein, the heat dissipation system operates at a preset heat dissipation temperature. By comparing the preset heat dissipation temperature with parameters of the temperature sensor arranged on the object to be cooled, when the actual temperature measured by the sensor exceeds the set value, the heat dissipation system is activated, and by opening the solenoid valve for pipeline connection, cooling water is transported to the object to be cooled in order to reduce the target problem. If the actual temperature measured by the sensor is lower than the set value, the battery valve for the corresponding pipeline is closed. Such a closed-loop cooling control scheme with active detection and active control can not only ensure the heat dissipation effect, but also reduce the continuous working time of the heat dissipation system, thus reducing energy consumption.

(9) Drainage system: After operation, the system will produce a large amount of water vapor, which is then collected into the water storage tank through the control of pneumatic components. Through the detection of the sensor, when the water storage tank exceeds a certain volume or height, the system can discharge the water vapor to the designated area under vacuum by switching of pneumatic valves.

During the operation of the equipment, especially after the microwave generator 104 is turned on to heat the materials, a large amount of water vapor will be generated in the chamber 101, which is then extracted from the chamber 101 and collected through the continuous operation of the vacuum unit 4 and the ultra-low temperature water-trapping system. Afterwards, the drainage system collects the liquid water produced by the condenser into the water collection tank through the control of pneumatic components. Detection is carried out by means of a level sensor provided in the water collection tank to continuously monitor the level of the water collection tank. When the water collection tank exceeds a certain volume or height, the drainage system will discharge the water stored in the water collection tank to the designated area by pipeline switching of pneumatic valves while the overall pipeline is under vacuum.

(10) Formula system: The formula is the core part of the entire electrical control system. During the drying process, the entire microwave generator 104 operates according to the set parameters in the formula system, such as temperature, pressure, and microwave operating time. These parameters can be detected through the temperature sensor and pressure sensor provided in the chamber 101 to ensure the smooth operation of the entire system. Herein, the specific settings of the formula parameters for material drying should be set according to the actual material needs to meet the drying effect of different materials. The specific drying parameter settings belong to the scope of prior art and will not be described in detail here. The formula number of each formula parameter entered into the formula system can be freely set as needed to facilitate real-time storing and calling.

(11) Detection system: the detection system also consists of multiple sensors with different functions, which are provided throughout the tunnel-type microwave vacuum ultra-low temperature drying equipment, in order to detect whether various parameters are in line with the requirements of the drying process. For example, the detection of material temperature in the chamber 101 in this example is achieved by a infrared sensor, mainly through the real-time detection of the temperature of different locations of the material in a non-contact manner in order to directly control the output power of the magnetron 1043. For another example, the detection of vacuum in the chamber 101 is achieved by a vacuum sensor. By providing the vacuum sensor in the chamber 101, the actual pressure value of the vacuum in the chamber 101 is detected to ensure that the material is dried under absolute vacuum. For yet another example, a temperature sensor is used for the real-time detection of the temperature of the temperature-controlled object in order to help the detection system to determine whether the temperature-controlled object needs to be cooled or heated for the purpose of precise control. For last example, a water flow detector may be provided in each cooling water pipeline to detect whether each water supply pipeline is in normal operation. A proximity sensor, a magnetic sensor, and other sensors may be arranged at the end of the chamber 101 to detect the open or closed state of the sealing door 103, and may also be provided inside the chamber 101 to detect whether the material is transported into the chamber 101 to determine the working state of the conveying line.

(12) Cooling system: When the microwave system completes its work as required, the cooling system is activated, at which time the microwave system is shut down and the microwave generator 104 stops working. The vacuum unit 4 is then controlled for a full-load vacuum extraction of the chamber 101 to further reduce the ambient temperature and material temperature in the chamber 101. After the cooling system completes the operation, the vacuum relief valve 108 is opened to evacuate the vacuum in the chamber 101 until the vacuum reaches a vacuum value that allows the door to be opened, thereby opening the sealing door 103.

(13) Alarm system: After the entire electrical control system starts to operate, the alarm system will carry out a self-test. If there is a fault during operation, the alarm devices mounted on the host device 1 and the auxiliary device are controlled to emit audible and visual alarms while displaying the fault points and fault elimination methods on the monitoring system. After the fault is eliminated, the fault alarm can be reset so that the alarm system continues to operate. When the alarm system detects a serious fault in the entire tunnel-type microwave vacuum ultra-low temperature drying equipment, the entire electrical control system should be controlled to shut down, and the system will not be allowed to resume operation until the fault is repaired.

(14) Communication system: The main controller of the electrical control system will intercommunicate with the power supply 1045 of the microwave, through which the working state of the microwave generator 104 can be viewed in real time and the working power of the microwave can be controlled. External systems can exchange data with the main controller through the communication system as required and operate in cooperation with each other.

(15) Monitoring system: The monitoring system is a visual monitoring system such as HMI or SCADA, which can view and control the operation of the entire electrical control system, and allows modification of the modifiable parameters of the electrical control system, changing the operation mode of the system, and viewing data records.

(16) Surveillance system: the surveillance system is mainly used for the material surveillance, conveying line surveillance, production surveillance, etc., and mainly serves the unmanned production mode. In the process of automatic operation of the entire electrical control system based on the preset parameters of the formula system, the operator on duty can check the status of the entire equipment production line through the monitor at the production site or in the main control room. In this example, the surveillance system consists of multiple cameras in order to perform real-time video surveillance of the site and store the video images in a specialized device, with functions such as viewing historical videos at any time. Meanwhile, the surveillance system also allows remote login to check on-site operations based on video.

(17) Remote monitoring system: The remote monitoring system allows users to check the operation of the entire tunnel-type microwave vacuum ultra-low temperature drying equipment in real time through the network locally or remotely, or to control the operation of the tunnel-type microwave vacuum ultra-low temperature drying equipment, to modify the parameters, and to view the historical data of equipment operation.

The electrical control system of the tunnel-type microwave vacuum ultra-low temperature drying equipment operates in an orderly manner through the unified coordination of the multiple systems, and completes the drying treatment of materials with a high of automation, which effectively saves labor costs and achieves high production efficiency.

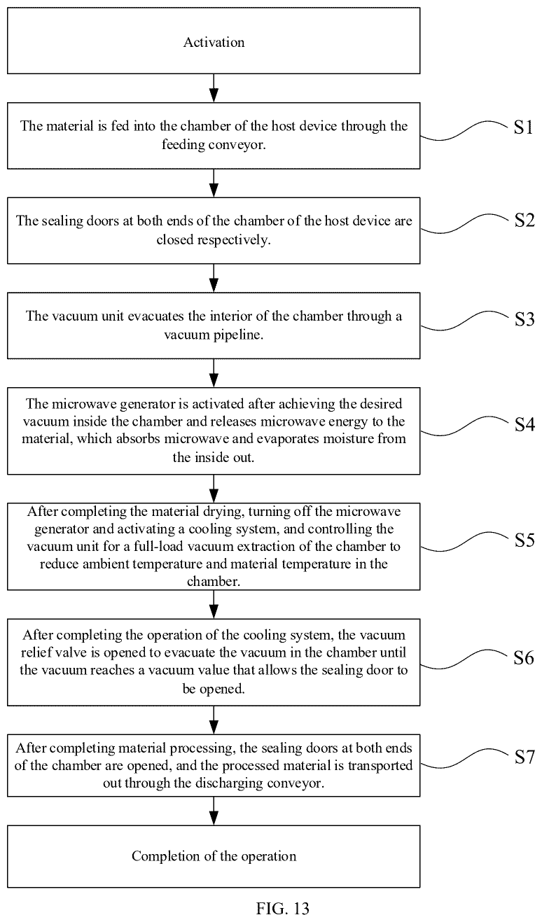

As shown in FIG. 13, under the control of the electrical control system, the material drying process of the tunnel-type microwave vacuum ultra-low temperature drying equipment is roughly as follows:

S1. The material is fed into the chamber 101 of the host device 1 through the feeding conveyor 2, and after the material is transported into the chamber 101 through the in-tunnel conveyor 111, the pressing cylinder 1091 of the pressing mechanism 109 pushes the pressing plate 1092 onto the material, so as to secure the material and prevent the material from scattering.

S2. The sealing doors 103 at both ends of the chamber 101 of the host device 1 are closed respectively.

S3. The vacuum unit 4 evacuates the interior of the chamber 101 through the vacuum pipeline 8.

S4. After the desired vacuum inside the chamber 101 is achieved, the microwave generator 104 is activated and releases microwave energy to the material, which absorbs microwave and evaporates moisture from the inside out. During the drying process, in order to ensure that the equipment is in normal operation, the vacuum unit 4, the ultra-low temperature water-trapping system, and the chiller unit 5 all need to work continuously, wherein the vacuum unit 4 rapidly extracts the moisture evaporated inside the chamber 101 to ensure that the chamber 101 is in a high vacuum state, allowing the water to have a low boiling point; the ultra-low temperature water-trapping system cools the extracted moisture, allowing gaseous water to convert into liquid water and be further concentrated; the chiller unit 5 provides water cooling for the magnetron 1043 and power supply to maintain the normal operation of the microwave generator 104, wherein the cooling tank 6 and the cooling tower 7 cooperate with the chiller unit 5 to work.

S5. After the material drying is completed, the microwave generator 104 is turned off and the cooling system is activated, and the vacuum unit 4 is controlled for a full-load vacuum extraction of the chamber 101 to reduce the ambient temperature and material temperature in the chamber 101.

S6. After the operation of the cooling system is completed, the vacuum relief valve 108 is opened to evacuate the vacuum in the chamber 101 until the vacuum reaches a vacuum value that allows the door to be opened.

S7. After the material processing is completed, the sealing doors 103 at both ends of the chamber 101 are opened while the pressing mechanism 109 is raised, and the processed material is transported out through the discharging conveyor 3.

The tunnel-type microwave vacuum ultra-low temperature drying equipment utilizes the characteristics of microwave heating that can cause the oscillation of polar molecules, supplemented by vacuum and water cooling functions to achieve drying by rapid low-temperature evaporation of water-containing materials in the chamber 101 in a vacuum environment. It makes up the defects of infrared auxiliary heating, air-cooled drying, spray drying, and other drying methods on the market. Meanwhile, the electrical control system ensures reliable operation of the equipment, making it suitable for drying various types of moist materials, especially special categories of flammable, explosive, and heat-sensitive materials.

Compared with other existing drying equipment, the equipment has a high material drying speed, a water evaporation efficiency of the microwave generator of approximately 1 kg/kw/h, high production capacity, uniform material drying, low energy consumption, and is environmentally friendly and pollution-free.

Although the specific embodiments of the present disclosure have been described above, those skilled in the art should understand that these are merely illustrative examples, and the scope of protection of the present disclosure is limited by the appended claims. Various changes or modifications can be made by those skilled in the art to these embodiments without departing from the principles and essence of the present disclosure, but these changes and modifications all fall within the scope of protection of the present disclosure.

What is claimed is:

1. A tunnel-type microwave vacuum ultra-low temperature drying equipment for drying a material, comprising:
a host device, comprising a chamber and a plurality of microwave generators, wherein the chamber has a cylindrical structure with an internal cross-sectional shape of a regular polygon; the plurality of microwave generators are respectively provided on an outer wall surface of the chamber and sequentially arranged at least along a lengthwise direction of the chamber;
a vacuum unit, having a vacuum port connected to the chamber through a pipeline;
a chiller unit, having a cooling water pipe connected to the microwave generator; the chiller unit is used to cool the microwave generator and a microwave power supply.

2. The tunnel-type microwave vacuum ultra-low temperature drying equipment according to claim 1, wherein the chamber comprises a plurality of sections of cylinders and a flange, and the sections of cylinders are connected to each other by the flange; and/or,
the chamber has an internal cross-sectional shape of a regular 24-sided polygon; and/or,
the chamber is made of mirror-finished stainless steel; and/or,
an electric heating pipe is provided at a bottom of the chamber.

3. The tunnel-type microwave vacuum ultra-low temperature drying equipment according to claim 1, wherein the microwave generators are located on both left and right sides of the chamber, and are provided on the chamber in a position corresponding to a shaped edge of the internal cross-sectional shape of the chamber; and/or,
the microwave generator comprises a power supply, a waveguide, a mounting flange, and a magnetron; the waveguide is mounted on an outer wall of the chamber by means of the mounting flange through distribution; the waveguide is mounted in conjunction with the magnetron; power is supplied to the magnetron by means of the power supply; the magnetron is controlled to activate and emit microwaves into a cavity of the waveguide, and the microwaves are reflected into the chamber by a cavity wall of the waveguide; and/or,
quartz glass is provided at a joint of the chamber and the microwave generator.

4. The tunnel-type microwave vacuum ultra-low temperature drying equipment according to claim 3, wherein the waveguide is one of a hard waveguide, a soft waveguide, a rectangular waveguide, and an elliptical waveguide.

5. The tunnel-type microwave vacuum ultra-low temperature drying equipment according to claim 1, wherein the chamber is provided with a cylindrical vacuum pipe; the vacuum port of the vacuum unit is connected to the cylindrical vacuum pipe through a pipeline; the chamber is provided with a vacuum relief valve; the vacuum relief valve, the cylindrical vacuum pipe, and the microwave generator are staggeredly arranged on a surface of the chamber; and/or,
the vacuum unit comprises one of the following three pumps:
(1) a combination of an oil-free screw vacuum pump and a Roots vacuum pump;
(2) a water ring vacuum pump;
(3) an oil pump.

6. The tunnel-type microwave vacuum ultra-low temperature drying equipment according to claim 1, wherein the tunnel-type microwave vacuum ultra-low temperature drying equipment further comprises an ultra-low temperature water-trapping system; the ultra-low temperature water-trapping system comprises a refrigeration unit, a heat exchanger, an evaporator, and a condenser; the vacuum port of the vacuum unit is connected to the chamber through the condenser and the evaporator of the ultra-low temperature water-trapping system.

7. The tunnel-type microwave vacuum ultra-low temperature drying equipment according to claim 6, wherein there are two ultra-low temperature water-trapping systems; the vacuum port is connected to the chamber through the condenser of one of the ultra-low temperature water-trapping systems by way of pipeline switching.

8. The tunnel-type microwave vacuum ultra-low temperature drying equipment according to claim 1, wherein a cooling water pipe is fixedly mounted at an external interface of the chiller unit; an interface end of the cooling water pipe is fixedly mounted and sealingly connected to a cooling interface end of power supply and magnetron of the microwave generator; and/or,
the tunnel-type microwave vacuum ultra-low temperature drying equipment further comprises a cooling tower, which is connected to the chiller unit and is used to provide refrigeration capacity to the chiller unit.

9. The tunnel-type microwave vacuum ultra-low temperature drying equipment according to claim 1, wherein the host device further comprises a sealing door and a sealing door moving mechanism; the sealing door is provided at an end of the chamber; the sealing door moving mechanism is connected to the sealing door and is used to drive the sealing door to switch between being closed and open relative to the end of the chamber;
when the sealing door is switched to being closed relative to the end of the chamber, the sealing door is sealingly connected to the end of the chamber;
when the sealing door is switched to being open relative to the end of the chamber, the end of the chamber opens outward.

10. The tunnel-type microwave vacuum ultra-low temperature drying equipment according to claim 9, wherein the tunnel-type microwave vacuum ultra-low temperature drying equipment further comprises a feeding conveyor and a discharging conveyor; the feeding conveyor is correspondingly provided at a feeding end of the chamber, and the discharging conveyor is correspondingly provided at the feeding end of the chamber;
the host device further comprises an in-tunnel conveyor provided within the chamber, with both ends of the in-tunnel conveyor extending to the feeding conveyor and the discharging conveyor respectively.

11. The tunnel-type microwave vacuum ultra-low temperature drying equipment according to claim 10, wherein the host device further comprises a pressing mechanism, which is provided within the chamber and located above the in-tunnel conveyor; the pressing mechanism is used to secure the material on the in-tunnel conveyor.

12. The tunnel-type microwave vacuum ultra-low temperature drying equipment according to claim 1, wherein the tunnel-type microwave vacuum ultra-low temperature drying equipment further comprises an auxiliary device; the vacuum unit and the chiller unit are both provided in the auxiliary device; the auxiliary device is provided separately from the host device; the vacuum unit in the auxiliary device is connected to the chamber in the host device through a vacuum pipe; the chiller unit in the auxiliary device is connected to the microwave generator in the host device through a cooling water pipe.

13. The tunnel-type microwave vacuum ultra-low temperature drying equipment according to claim 12, wherein the tunnel-type microwave vacuum ultra-low temperature drying equipment further comprises an electrical control module provided near the host device.

14. A material drying process that uses the tunnel-type microwave vacuum ultra-low temperature drying equipment according to claim 1 for drying a material, specifically comprising the following steps:
feeding the material into the chamber of the host device through the feeding conveyor;
closing the sealing doors at both ends of the chamber of the host device respectively;
using the vacuum unit to evacuate the interior of the chamber through a vacuum pipeline;
activating the microwave generator after achieving a desired vacuum inside the chamber and releasing microwave energy to the material, which absorbs microwave and evaporates moisture from the inside out;
turning off the microwave generator and activating a cooling system after completing material drying, and controlling the vacuum unit for a full-load vacuum extraction of the chamber to reduce ambient temperature and material temperature in the chamber;
opening the vacuum relief valve after completing the operation of the cooling system to evacuate the vacuum in the chamber until the vacuum reaches a vacuum value that allows the sealing door to be opened;
opening the sealing doors at both ends of the chamber after completing material processing, and transporting out the processed material through the discharging conveyor.

15. The material drying process according to claim 14, wherein the step of feeding the material into the chamber of the host device through the feeding conveyor further comprises: after transporting the material into the chamber through the in-tunnel conveyor, controlling a pressing cylinder of the pressing mechanism to push a pressing plate onto the material, so as to secure the material and prevent the material from scattering; and/or,
the step of activating the microwave generator after achieving a desired vacuum inside the chamber and releasing microwave energy to the material, which absorbs the microwave and evaporates moisture from the inside out further comprises at least one of the following three steps:
(1) using the vacuum unit to rapidly extract the moisture evaporated inside the chamber to ensure that the chamber is in a high vacuum state, allowing water to have a low boiling point;
(2) using the ultra-low temperature water-trapping system to cool the moisture extracted by the vacuum unit, allowing gaseous water to convert into liquid water and be further concentrated;
(3) using the chiller unit for water cooling of the magnetron and power supply to maintain normal operation of the microwave generator.
